(19) United States
(12) Patent Application Publication
(10) Pub. No.: US 2022/0027349 A1
(43) Pub. Date: Jan. 27, 2022

(54) EFFICIENT INDEXED DATA STRUCTURES FOR PERSISTENT MEMORY

(71) Applicant: Alibaba Group Holding Limited, Grand Cayman (KY)

(72) Inventors: Chen Shuo, Bothell, WA (US); Qingda Lu, Bellevue, WA (US); Jiesheng Wu, Redmond, WA (US); Zhu Pang, Bellevue, WA (US); Yuanjiang Ni, Santa Cruz, CA (US)

(21) Appl. No.: 16/938,399

(22) Filed: Jul. 24, 2020

(51) Int. Cl. G06F 16/23; G06F 16/22

(52) U.S. Cl. CPC G06F 16/2379; G06F 16/2282

(57) ABSTRACT

Indexed data structures are provided which are optimized for read and write performance in persistent memory of computing systems. Stored data may be searched by traversing an indexed data structure while still being sequentially written to persistent memory, so that the stored data may be accessed more efficiently than on non-volatile storage, while maintaining persistence against system failures such as power cycling. Mapping correspondences between leaf nodes of an indexed data structure and sequential elements of a sequential data structure may be stored in RAM, facilitating fast random access. Data writes are recorded as appended delta encodings which may be periodically compacted, avoiding write amplification inherent in persistent memory. Delta encodings are stored in iterative flows, such as log streams, enabling access to multiple buckets of data in parallel, while also providing a chronological record to enable recovery of mapping correspondences in RAM, guarding non-persistent data against system failures.

### BACKGROUND

In computing, it is desired to store data in manners which forestall data loss in the event of potential failures of computing systems, such as unexpected power loss leading to power cycling. Various features of computing hardware and/or software have been devised in advancing such goals. For example, persistent memory is a new design for storage media in computing devices seeking to provide advantages that current hardware does not.

In hardware, computing systems generally include a variety of volatile and non-volatile storage media, where volatile storage media tends to be faster in performance measures such as read and write speed, while non-volatile storage media tends to be slower in performance measures. For example, various forms of random-access memory (“RAM”), as volatile storage media, provide fast read and write access but lose data quickly upon loss of power. Magnetic storage drives, flash memory such as solid state drives, and read-only memory (“ROM”), as non-volatile storage media, may store data through power loss.

In contrast, persistent memory may be both random access and non-volatile: persistent memory technologies may be designed to achieve both the rapid random access of conventional RAM and the persistence of data through power cycling. This distinguishes persistent memory from dynamic random-access memory (“DRAM”), which generally makes up the primary memory of a computing system, providing the fastest read and write access out of all storage media of the computing system.

Persistent memory generally exhibits asymmetry in random accesses, supporting fast read operations but slow write operations. Consequently, just as data structures are conventionally designed differently for storage in memory as opposed to storage in non-volatile storage media, so as to maximize the respective strengths of each type of storage media and minimize their respective weaknesses, so must data structures be re-conceptualized for persistent memory, which combines aspects of both technologies.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a system architecture of a system configured for any general-purpose or special-purpose computations according to example embodiments of the present disclosure.

FIG. 2 illustrates an architectural diagram of a data structure indexing data stored on persistent memory according to example embodiments of the present disclosure.

FIGS. 3A and 3B illustrate a hierarchical data structure according to example embodiments of the present disclosure as a B+ tree.

FIG. 3C illustrates iterative flows implemented on a sequential data structure 208 according to example embodiments of the present disclosure.

FIG. 3D illustrates mapping correspondences according to example embodiments of the present disclosure.

FIG. 4 illustrates a flowchart of a data search method according to example embodiments of the present disclosure.

FIG. 5 illustrates a flowchart of a data update method according to example embodiments of the present disclosure.

FIG. 6 illustrates defragmentation in a sequential data structure according to example embodiments of the present disclosure.

FIG. 7 illustrates recovery of mapping correspondences according to example embodiments of the present disclosure.

FIG. 8 illustrates an example computing system for implementing the data structures described above optimized for read and write performance in persistent memory of computing systems.

### DETAILED DESCRIPTION

Systems and methods discussed herein are directed to implementing a data structure, and more specifically implementing an indexed data structure optimized for read and write performance in persistent memory of computing systems.

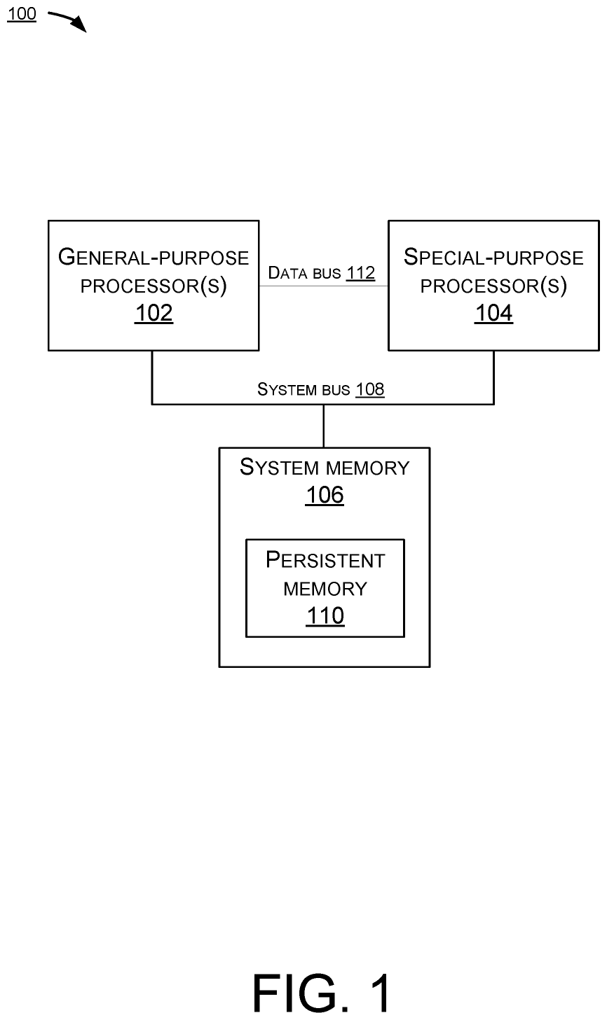

FIG. 1 illustrates a system architecture of a system 100 configured for any general-purpose or special-purpose computations according to example embodiments of the present disclosure.

A system 100 according to example embodiments of the present disclosure may include one or more general-purpose processor(s) 102 and may further include one or more special-purpose processor(s) 104. The general-purpose processor(s) 102 and special-purpose processor(s) 104 may be physical or may be virtualized and/or distributed. The general-purpose processor(s) 102 and special-purpose processor(s) 104 may execute one or more instructions stored on a computer-readable storage medium as described below to cause the general-purpose processor(s) 102 or special-purpose processor(s) 104 to perform a variety of functions. Special-purpose processor(s) 104 may be computing devices having hardware or software elements facilitating computation of specialized mathematical computing tasks. For example, special-purpose processor(s) 104 may be accelerator(s), such as Neural Network Processing Units (“NPUs”), Graphics Processing Units (“GPUs”), Tensor Processing Units (“TPU”), implementations using field programmable gate arrays (“FPGAs”) and application specific integrated circuits (“ASICs”), and/or the like. To facilitate specialized computation, special-purpose processor(s) 104 may, for example, implement engines operative to compute mathematical operations (such as, matrix operations and vector operations).

A system 100 may further include a system memory 106 communicatively coupled to the general-purpose processor(s) 102, and to the special-purpose processor(s) 104 where applicable, by a system bus 108. The system memory 106 may be physical or may be virtualized and/or distributed. Depending on the exact configuration and type of the system 100, the system memory 106 may be volatile, such as RAM, non-volatile, such as ROM, flash memory, miniature hard drive, memory card, and the like, or some combination thereof.

According to example embodiments of the present disclosure, the system memory 106 may further include persistent memory 110. Persistent memory 110 may generally be implemented as various forms of non-volatile memory (“NVM”) or non-volatile random-access memory (“NVRAM”) which supports byte-addressable random access to data stored thereon. A variety of otherwise heterogeneous semiconductor implementations of computer-readable storage media each have such qualities of persistent memory 110 as described herein with reference to FIG. 1, such as phase-change memory (“PCM”), resistive random-access memory (“ReRAM”), magnetoresistive random-access memory (“MRAM”), non-volatile dual in-line memory modules (“NVDIMM”), and the like.

However, though each such semiconductor technology may implement persistent memory 110 according to example embodiments of the present disclosure, the concept of persistent memory is not limited to the physical capacities of NVM or NVRAM as described above. The concept of persistent memory may further encompass functionality as both short-term storage and long-term storage, as persistent memory may, beyond implementing conventional memory addressing, additionally implement a file system establishing a structure for storage and retrieval of data in the form of individual files.

The system bus 108 may transport data between the general-purpose processor(s) 102 and the system memory 106, between the special-purpose processor(s) 104 and the system memory 106, and between the general-purpose processor(s) 102 and the special-purpose processor(s) 104. Furthermore, a data bus 112 may transport data between the general-purpose processor(s) 102 and the special-purpose processor(s) 104. The system bus 108 and/or the data bus 112 may, for example, be Peripheral Component Interconnect Express (“PCIe”) interfaces, Coherent Accelerator Processor Interface (“CAPI”) interfaces, Compute Express Link (“CXL”) interfaces, Gen-Z interfaces, RapidIO interfaces, and the like. As known to persons skilled in the art, some such interfaces may be suitable as interfaces between processors and other processors; some such interfaces may be suitable as interfaces between processors and memory; and some such interfaces may be suitable as interfaces between processors and persistent memory.

In practice, various implementations of persistent memory tend to exhibit certain advantages and disadvantages of random-access memory, as well as certain advantages and disadvantages of non-volatile storage media. For example, while implementations of persistent memory may permit fast random-access reads of data, random-access writes of data may exhibit greater latency, especially with respect to operations such as inserts and deletes in indexed data structures, such as lists and arrays, which support such operations. This may result from the access granularity of various persistent memory implementations: while memory random-access is byte-addressable, persistent memory implementations based on flash memory (such as, for example, NVDIMM) may only be able to write data upon erasing data blocks of fixed size, resulting in the phenomenon of write amplification as known in the art, wherein write accesses of size smaller than the access granularity of the underlying flash memory lead to a cascade of moving and rewriting operations which substantially increase write latency. This phenomenon may be particularly exacerbated in the case of random access, such as inserts, deletes, and the like.

Moreover, persistent memory may be used to implement storage for database systems (both in the form of in-memory databases and in the form of file system-based databases), thus necessitating the implementation of database transaction guarantees as known to persons skilled in the art, such as atomicity, consistency, isolation, and durability (“ACID”). For example, atomicity ensures that individual transactions will not be partially performed, so that a database being updated will not be left in a partially updated state in the event of a system failure. However, the nature of persistent memory means that even when data persists through system failures, properties such as atomicity and consistency of data writes may not be guaranteed. Due to write amplification and relatively large access granularity, when conventional database systems are stored on persistent memory, ACID properties such as atomicity may not be guaranteed through system failures, as the latency incurred by updating such database systems on persistent memory means system failures could occur mid-update. Database systems which do not satisfy such guarantees may be unreliable for practical applications.

Certain database design techniques have been proposed for implementing database structures while guaranteeing some of the ACID properties, though at greater expense of access latency and computational overhead. For example, write-ahead logging (“WAL”) is a proposed technique wherein pending updates, such as inserts and deletions, to an indexed data structure are first logged in a sequential data structure not in random-access memory by an append operation, thus allowing the pending inserts to be recorded on a persistent basis. Subsequently, the pending updates to the indexed data structure may be committed by reference to information logged in the sequential data structure; though these updates may not be atomic, even if a system failure occurs in the middle of committing pending updates, ACID properties such as consistency may be guaranteed due to the sequential data structure providing a record from which the pending updates may be correctly performed.

Furthermore, validity bitmaps are a proposed technique wherein occupancy of each slot of an indexed data structure is tracked using a bitmap mapping each slot to a representation thereof in bits. Thus, ahead of pending updates to the indexed data structure, the validity map may be searched to identify slots where inserts may be performed. However, computational overhead of searching a validity bitmap may scale arbitrarily according to size of a validity bitmap.

Furthermore, BW-trees are a proposed technique wherein updates to an indexed data structure are recorded as “delta records” which are indirectly mapped to previously written records; consecutively recorded delta records may form a “delta chain.” Delta records may be occasionally compacted with existing records.

None of these techniques, moreover, are tailored to the special challenges of a database system stored on persistent memory. In each of these cases, random accesses are still required in order to update an indexed data structure holding the data being updated, and, in each case, write amplification effects leading to write latency will result from such random accesses. However, each layer of indirection mapping increases computation overhead of traversing the overall indexed data structure for read and write access.

Thus, in order to implement database systems stored at least in part in persistent memory, so that computing systems utilizing persistent memory may be deployed for practical applications which require data storage, database backends, and the like. So that the advantages of persistent memory are realized while avoiding the limitations of persistent memory, it is desirable to design specialized data structures which may be read from and written to efficiently when stored on persistent memory.

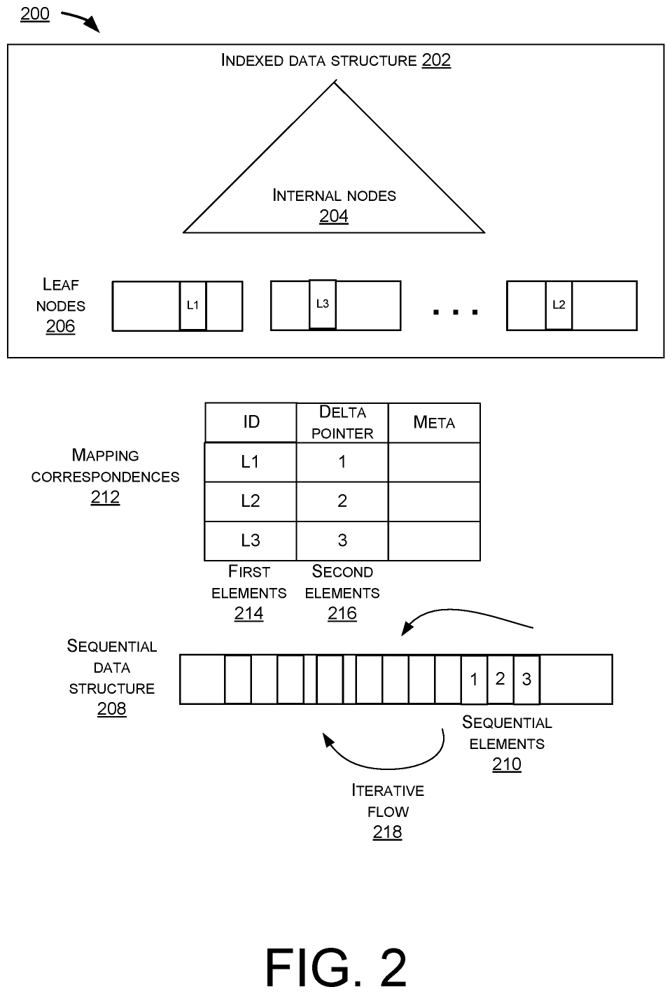

FIG. 2 illustrates an architectural diagram of a data structure 200 indexing data stored on persistent memory according to example embodiments of the present disclosure.

According to example embodiments of the present disclosure, elements of the data structure 200 may include an indexed data structure 202. The indexed data structure 202 may be any data structure as known to persons skilled in the art which may record any number of elements (as shall be described in further detail subsequently) which may be indexed by a sorted key.

The indexed data structure 202 may be a hierarchical data structure organized into levels higher and lower relative to each other. Levels of the indexed data structure 202 may include elements such as internal nodes 204 and child leaf nodes 206, linked hierarchically by pointers. Each internal node 204 may be a node linked to at least one node of a lower level than the internal node 204 by a pointer, and each child leaf node 206 may be a node not linked to any nodes of a lower level than the child leaf node 206.

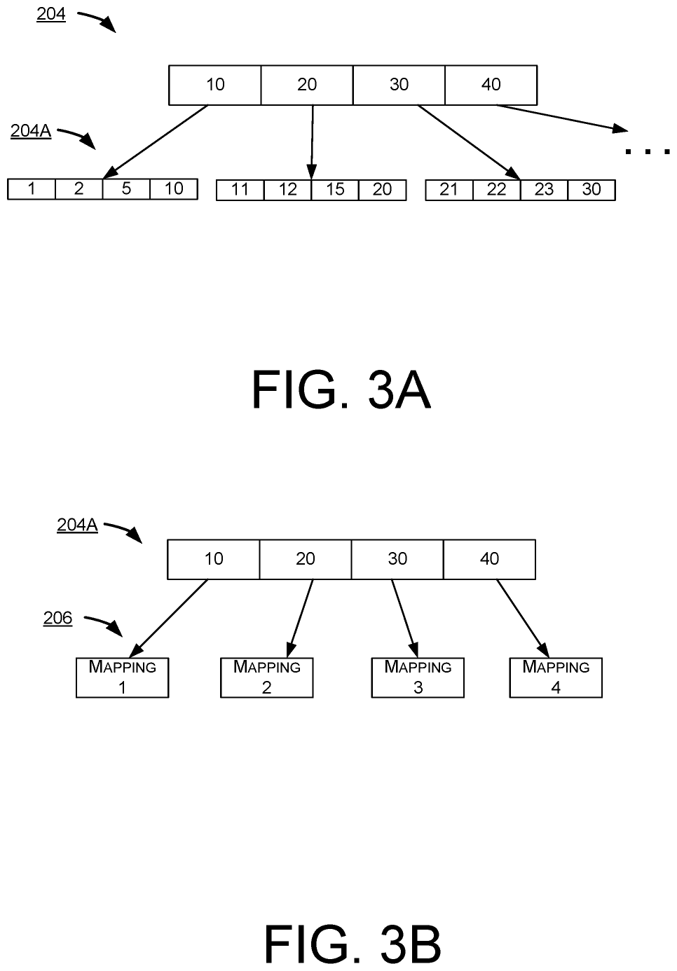

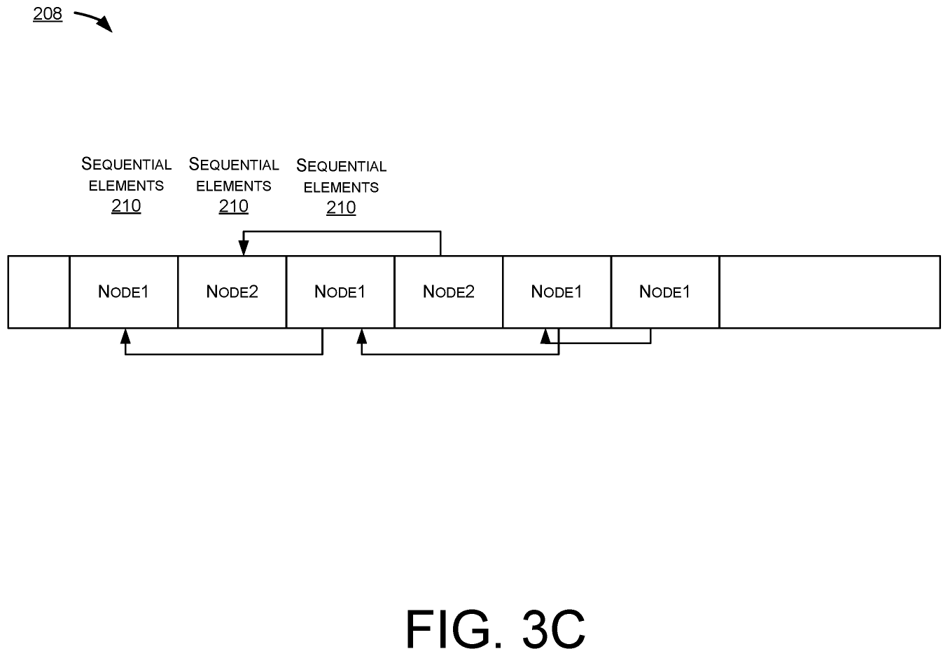

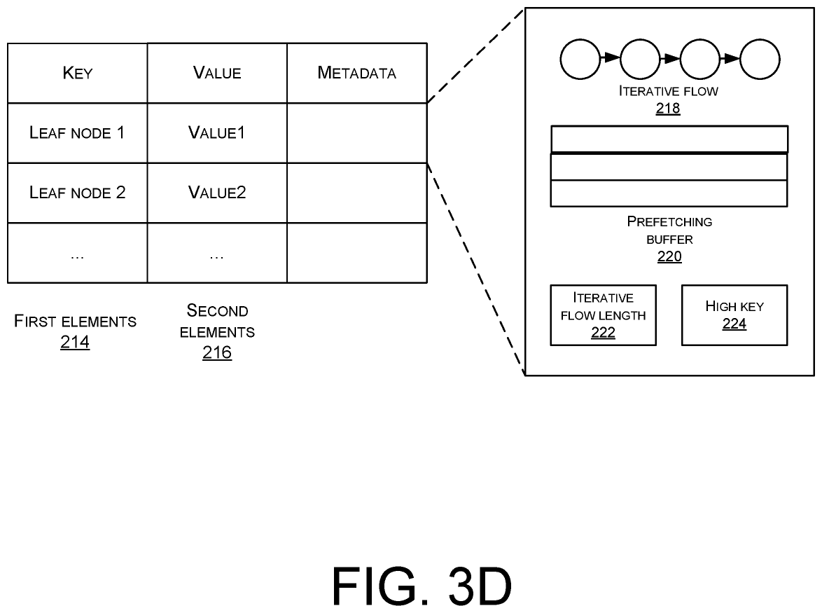

For example, according to example embodiments of the present disclosure, the hierarchical data structure may be a B+ tree as illustrated in FIGS. 3A and 3B. As FIG. 3A illustrates, each internal node 204 may store a key value, and internal nodes 204 of a same hierarchical level may be sorted in key value order (as illustrated, the key values 10, 20, 30, and 40 of four internal nodes 204 of a same hierarchical level are sorted in ascending order). Each internal node 204 may have one or more child internal nodes 204A, where child internal nodes 204A of a same internal node 204 may be sorted in key value order (as illustrated, the key values 1, 2, 5, and 10 of four child internal nodes 204A of an internal node 204 are sorted in ascending order).

Furthermore, key values of each internal node 204 may constrain a range of key values that child internal nodes 204A of that internal node 204 may have (as illustrated, the key values 1, 2, 5, and 10 of four child internal nodes 204A of a first internal node 204 having key value 10 have key values no greater than the key value 10; the key values 11, 12, 15, and 20 of four child internal nodes 204A of a second internal node 204 having key value 20 have key values no greater than the key value 20, and so on). Furthermore, respective key value ranges of child internal nodes 204A of each internal node 204 may be mutually non-overlapping.

In the indexed data structure 202, internal nodes 204 are generally traversed more frequently than leaf nodes 206, due to the operations of search methods. Thus, it may be desired to enable faster read and write access to the internal nodes 204 than non-volatile storage can provide, due to non-volatile storage reads and writes generally being sequential and often relying on physically moving components. In accordance, the indexed data structure 202 may be implemented in persistent memory so as to enable faster access than storage in non-volatile storage, while still ensuring persistence of data through power cycling and system failures.

Furthermore, pending writes to internal nodes 204 of the indexed data structure 202 may be recorded by WAL to an undo log record stored on persistent memory, so as to record the pending writes on a persistent basis in the event of power cycling and system failures, guaranteeing ACID properties such as consistency.

As FIG. 3B illustrates, internal nodes 204 may have child leaf nodes 206 instead of child internal nodes 204A. Child leaf nodes 206 may, rather than having key values, be instead mapped to a sequential element 210 of a sequential data structure 208 by a mapping correspondence 212 as described in further detail subsequently. For example, a child leaf node 206 may record a unique identifier which may be mapped uniquely by a hash algorithm as known to persons skilled in the art to one of a collection of data structures.

Child leaf nodes may implement an indirection layer which logically organizes data stored in the overall data structure 200 without directly storing the data. The effect of the indirection layer may be to record pending writes by appends to a sequential data structure, allowing writes to be batched prior to compacting and commitment in persistent memory. Batching writes for compaction may reduce the deleterious effects of write amplification as described above. Thus, child leaf nodes 206 are not stored on persistent memory as internal nodes 204 are, and may be part of the implementation of mapping correspondences 212 as described subsequently.

Utilizing the indexed and hierarchical nature of the indexed data structure 202, operations may be implemented to search the indexed data structure 202 for elements having indexes of particular values; insert elements having indexes of particular values in appropriate positions in the indexed data structure 202; remove elements having indexes of particular values from the indexed data structure 202; rearrange elements of the indexed data structure 202 to preserve the sorted key order; and the like. For example, the hierarchical data structure may be a tree structure; the tree structure may be indexed by a sorted key as described above, and search, insert, and delete operations may be implemented for the tree structure according to the sorted key by techniques as known to persons skilled in the art.

According to example embodiments of the present disclosure, elements of the data structure 200 may further include a sequential data structure 208. The sequential data structure 208 may be any data structure as known to persons skilled in the art which may record any number of sequential elements 210 which may only be traversed in one particular order. For example, the sequential data structure 208 may be a linked list, an array, a circular buffer, and other such data structures. Furthermore, iterative flows may be implemented on the sequential data structure 208. Iterative flows for the purpose of example embodiments of the present disclosure may refer to a function interface or a collection of function interfaces implemented based on any such above data structures which enable sequential elements 210 linked by the iterative flow to be accessed one at a time in order, such as a function interface which describes instructions executable by a computing system to retrieve a next sequential element 210 of the iterative flow, and other such function interfaces as known to persons skilled in the art. For example, a log stream may be an implementation of iterative flows.

FIG. 3C illustrates iterative flows implemented on a sequential data structure 208 according to example embodiments of the present disclosure. Sequential elements 210 have been recorded in the sequential data structure 208. However, the iterative flows implemented on the sequential data structure 208 are further illustrated as the multiple arrows leading among the sequential elements 210. For example, by implementing a log stream on the sequential data structure 208, one or more function interfaces embodying the log stream may be called to retrieve a next sequential element 210 from a current sequential element, “current” and “next” being defined according to the arrows as illustrated connecting sequential elements 210.

Generally, iterative flows as implemented connect each sequential element 210 to only one next sequential element 210, though more than one iterative flow may be implemented in parallel among different groupings of sequential elements 210 in this manner so that no individual sequential element 210 has more than one next sequential element 210. For example, as illustrated, a first log stream includes each sequential element 210 labeled “Node 1,” and a second log stream includes each sequential element 210 labeled “Node2.” The first log stream includes no sequential element 210 of the second log stream, and vice versa. Within the first log stream, sequential elements 210 labeled “Node1” may be accessed one at a time in accordance with arrows as illustrated in FIG. 3C, not necessarily in the order in which they have been recorded in the sequential data structure 208. Within the second log stream, sequential elements 210 labeled “Node2” may be accessed one at a time in accordance with arrows as illustrated in FIG. 3C, not necessarily in the order in which they have been recorded in the sequential data structure 208.

Thus, example embodiments of the present disclosure provide a data structure 200 which includes hybrid features of an indexed data structure 202 and a sequential data structure 208. By the indexed data structure 202 stored on persistent memory, data may be read efficiently while remaining persistent against system failures; by the mapping correspondences implementing an indirection layer in RAM, sequential batched writes may be queued and written in a compacted and sequential manner, reducing the effects of write amplification inherent to persistent memory, and utilizing write bandwidth of persistent memory in an efficient manner by preferentially utilizing sequential writes.

Thus, in conjunction with the indexed data structure 202 as described above, the sequential data structure 208 may store data of the overall data structure 200 in persistent memory, each uniquely indexed by a different child leaf node 206 mapping writes to the data in an indirection layer in RANI, searchable by the indexed data structure 202 in persistent memory. According to example embodiments of the present disclosure, a write to data indexed by a child leaf node 206 may be recorded as a delta encoding, each delta encoding being recorded as a sequential element 210 of the sequential data structure 208. A delta encoding may include at least one key and at least one value corresponding to the key, describing changes which should be made to a key and a corresponding value indexed at the child leaf node 206. Consecutive writes to data indexed by a child leaf node 206 may be recorded as consecutive delta encodings sequentially written and accessed through iterative flows implemented as described above.

Thus, data stored in the overall data structure 200 data may be indexed by individual child leaf nodes 206, but the current state of the data should be read and written to by looking up a child leaf node 206 by the indexed data structure 202, and then reconstructed by applying each delta encoding (i.e., sequential elements 210) of an iterative flow pointed to by the child leaf node 206. Since an iterative flow is sequentially accessed, the child leaf node 206 needs only to point to a sequential element 210 at a head of the iterative flow in order to allow all sequential elements 210 of the entire iterative flow to be accessed.

A delta encoding according to example embodiments of the present disclosure may describe a differential update to be applied to data indexed by the child leaf node 206 which points to the iterative flow (i.e., points to a head sequential element 210 of a log stream), such that application of updates recorded in each delta encoding of the iterative flow reconstructs the current state of the data indexed by the child leaf node 206.

Example embodiments of the present disclosure further provide mapping correspondences 212. Mapping correspondences 212 may be any suitable data structure as known to persons skilled in the art which may record one-to-one correspondences between first elements 214 and second elements 216. For example, mapping correspondences 212 may be a key-value store, a dictionary, a hash table, a hash map, or any such related data structures as known to persons skilled in the art. First elements 214, according to example embodiments of the present disclosure, may be leaf nodes 206 of the indexed data structure 202. Second elements 216, according to example embodiments of the present disclosure, may be sequential elements 210 of the sequential data structure 208. The mapping correspondences 212 may enable a first element 214 to be looked up to retrieve a second element 216.

The mapping correspondences 212 may further store information and/or data structures such as a length of elements in an iterative flow, a value of a highest key in the iterative flow (henceforth referred to as a “high key”), a prefetching buffer, and the like in association with each individual first element 214-second element 216 mapping.

By a further consequence of example embodiments of the present disclosure as described above, the mapping correspondences 212 may be stored entirely in RAM (such as DRAM) so as to enable fast random access.

FIG. 3D illustrates mapping correspondences 212 according to example embodiments of the present disclosure. Herein, mapping correspondences 212 are illustrated as a table for simplified presentation, though this illustrated table may represent any suitable data structure as described above. First elements 214 are illustrated in a left column of the mapping correspondences 212. Second elements 216 are illustrated in a right column of the mapping correspondences 212. Each individual first element 214-second element 216 mapping effectively points to, as illustrated to the right of the mapping correspondences 212, an iterative flow 218, though it does not need to point to the entire iterative flow 218; as described above, pointing to a head sequential element 210 of the iterative flow 218 enables read and write access to all sequential elements 210 of the iterative flow 218. Thus, the entirety of the iterative flow 218 being illustrated in FIG. 3D is merely for the purpose of conceptual understanding of the invention, and should not be viewed as literally the entire iterative flow 218 being stored in the mapping correspondences 212.

Each individual first element 214-second element 216 mapping may be further stored in association with a prefetching buffer 220. A prefetching buffer 220 may be implemented by data structures such as a circular buffer as known to persons skilled in the art.

Each individual first element 214-second element 216 mapping may be further stored in association with an iterative flow length 222 and a high key 224 as described above.

Given a data structure 200 having the above architecture, example embodiments of the present disclosure further provide methods of utilizing the data structure 200, stored across RAM and persistent memory, so as to store data in persistent memory of a computing system while indexing the stored data in RAM for fast random access.

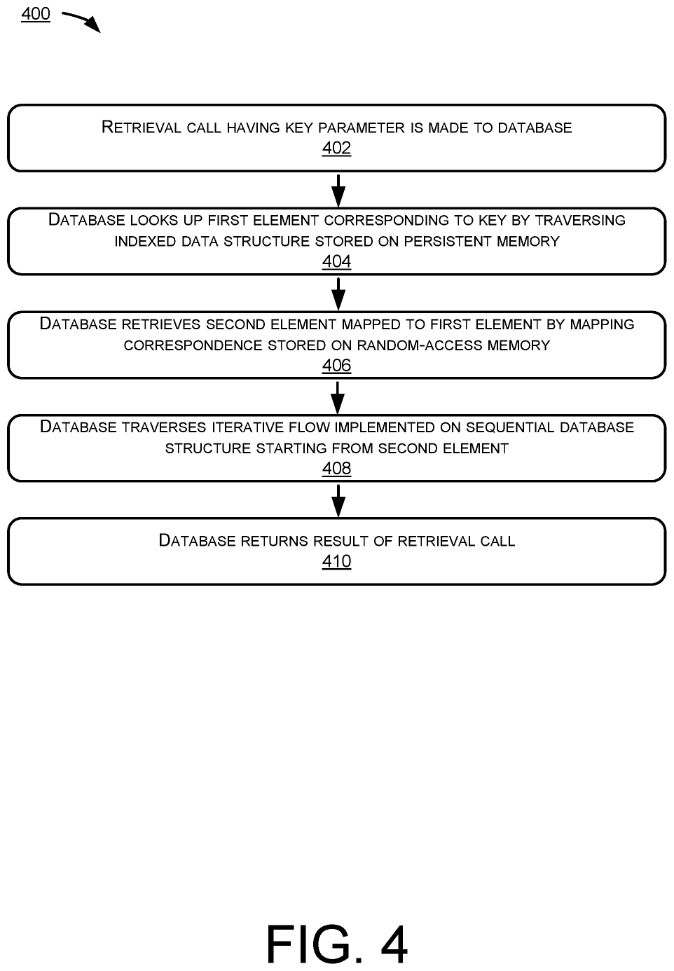

FIG. 4 illustrates a flowchart of a data search method 400 according to example embodiments of the present disclosure. The data search method 400 may be described with reference to the data structure 200 as described above.

At a step 402, a retrieval call having a key parameter is made to a database, the database comprising a data structure stored at least in part on random-access memory and at least in part on persistent memory.

The data structure may be implemented in accordance with the data structure 200 as described above, including an indexed data structure 202 implemented in persistent memory and mapping correspondences 212 implemented in RAM.

The data structure may be implemented as part of a file system incorporating a database, and the database may be operative to perform functions as generally established by key-value databases and other non-relational databases as known to persons in the art. In such configurations, the data structure may perform roles of memory tables, cache systems, sorted maps, metadata management systems for storage file systems, and the like. Thus, the database may implement a function interface or a collection of function interfaces which may be called to read data stored in the data structure, write data to the data structure, sort data stored in the data structure, copy data stored in the data structure, delete data stored in the data structure, determine properties of data stored in the data structure, set values of data stored in the data structure, execute computer-executable instructions upon data stored in the data structure, and the like.

A retrieval call may be an example of such a function interface, and may function in a manner operative to retrieve data from key-value databases and other non-relational databases in general. Common examples of retrieval calls in database systems include GET commands as commonly implemented, taking one or more keys as arguments. Thus, such a retrieval call may request the data structure to look up data corresponding to a key value associated with the data.

At a step 404, the database looks up a first element corresponding to the key by traversing an indexed data structure stored on persistent memory.

As described above, the indexed data structure may be indexed by a sorted key, and may be a hierarchical data structure having multiple levels. Thus, the database may traverse the indexed data structure by any method known to persons skilled in the art, such as breadth-first search, depth-first search, and other searches as known to persons skilled in the art. According to example embodiments of the present disclosure wherein the hierarchical data structure is a B+ tree, the database may traverse the hierarchical data structure by breadth-first search.

According to breadth-first search, the database may traverse each level of the hierarchical data structure and find an internal node having a smallest key at that level which is higher than the lookup key. The database may then traverse to a next lower level of the hierarchical data structure following a pointer from the internal node to a child leaf node of the internal node. The database may traverse to each next lower level of the hierarchical data structure in this manner until a lowermost level of the hierarchical data structure is reached.

At a step 406, the database retrieves a second element mapped to the first element by a mapping correspondence stored on random-access memory.

The key value may be a first element as described above, which may be stored in association with a second element in mapping correspondences as described above. The second element may be a sequential element of a sequential data structure as described above. Thus, by looking up a first element corresponding to the key value in the mapping correspondences, the database may retrieve a second element mapped to the first element.

At a step 408, the database traverses an iterative flow implemented on a sequential database structure starting from the second element.

As described above, the iterative flow provides one or more function interfaces which may be called to access each sequential element linked by the iterative flow, one at a time, in order. Starting from the second element, the database may traverse at least once over each sequential element of the iterative flow to the end of the iterative flow. By traversing over the iterative flow and reading each sequential element, the database may determine one or more values indexed by the lookup key specified by the retrieval call and determine whether any values requested by the retrieval call are returnable in response to the retrieval call, and, if so, what values those are.

A further advantage of example embodiments of the present disclosure is that multiple iterative flows of data mapped to multiple child leaf nodes may each be traversed in parallel by multiple search threads initialized by the database. Such concurrent computing may enable computing power of a computing system to be utilized with heightened efficiency.

At a step 410, the database returns a result of the retrieval call.

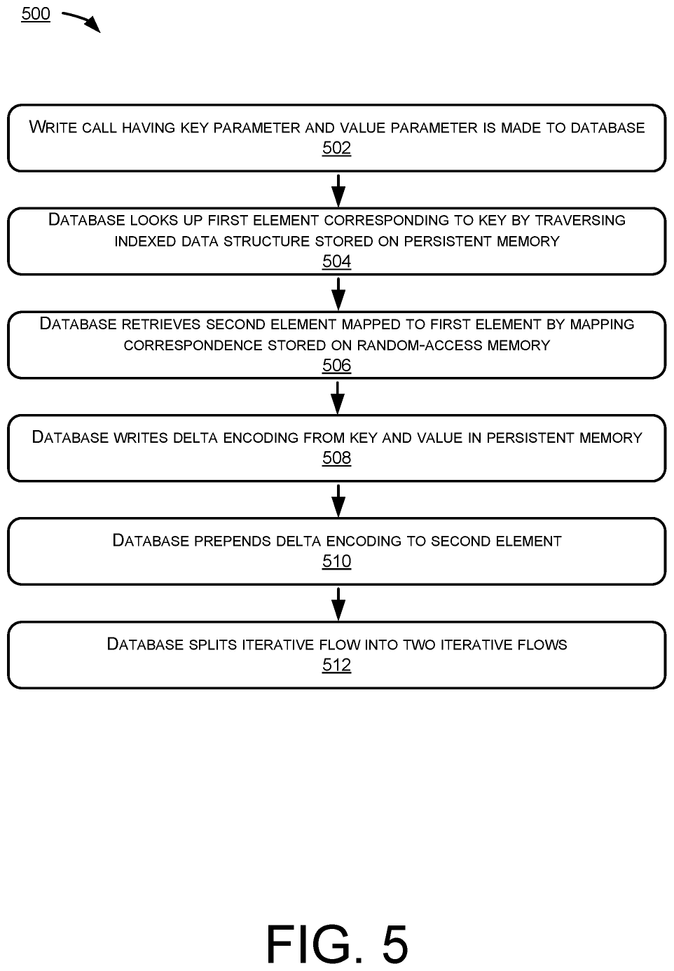

FIG. 5 illustrates a flowchart of a data update method 500 according to example embodiments of the present disclosure. The data update method 500 may be described with reference to the data structure 200 as described above.

At a step 502, a write call having a key parameter and a value parameter is made to a database, the database comprising a data structure stored at least in part on random-access memory and at least in part on persistent memory.

The data structure may be implemented in accordance with the data structure 200 as described above, including an indexed data structure 202 implemented in persistent memory and mapping correspondences 212 implemented in RAM.

As described above, the data structure may be implemented as a database for a file system, and the database may be operative to perform functions as generally established by key-value databases and other non-relational databases as known to persons in the art. Thus, the database may implement a function interface or a collection of function interfaces which may be called to read data stored in the data structure, write data to the data structure, sort data stored in the data structure, copy data stored in the data structure, delete data stored in the data structure, determine properties of data stored in the data structure, set values of data stored in the data structure, execute computer- executable instructions upon data stored in the data structure,

A write call may be an example of such a function interface, and may function in a manner operative to write a value corresponding to a key to data in key-value databases and other non-relational databases in general. Common examples of write calls in database systems include POP, PUSH, APPEND, and such commands as commonly implemented, taking one or more keys and one or more values as arguments. Thus, such a retrieval call may request the data structure to write or update one or more values corresponding to a key value.

At a step 504, the database looks up a first element corresponding to the key by traversing an indexed data structure stored on persistent memory.

At a step 506, the database retrieves a second element mapped to the first element by a mapping correspondence stored on random-access memory.

The above steps proceed substantially similarly to the corresponding steps 404 and 406 as described above in reference to FIG. 4.

At a step 508, the database writes a delta encoding from the key and the value in persistent memory.

According to example embodiments of the present disclosure, the delta encoding may describe a differential update to be applied to data indexed at the key which points to the second element, such that application of updates recorded in each delta encoding of a same iterative flow as the second element reconstructs the current state of the data indexed at the key.

Upon reconstructing the current state of the data indexed at the key, the database may determine a differential update to be applied thereto in order to change the current state of the data to the key and value as specified by the write call. This differential update may then be written to persistent memory as a delta encoding.

At a step 510, the database prepends the delta encoding to the second element.

As described above, the second element may be at a head of an iterative flow of sequential elements. Thus, prepending the delta encoding to the second element (i.e., appending the iterative flow starting from the second element to a tail of the delta encoding) may establish a new iterative flow starting from the delta encoding.

Among the ACID properties of the prepending operation, at least atomicity may be guaranteed by setting a read and write lock to the mapping from the first element to the second element (i.e., the mapping which points to the head of the iterative flow) during the prepending operation. By preventing read and write operations from other threads concurrent to the prepending operation, results of the prepending operation cannot be affected by a multithreading environment.

Optionally, at a step 512, the database splits the iterative flow into two iterative flows.

Iterative flows becoming exceedingly long in the number of sequential elements (i.e., delta encodings) contained therein may lead to overly high traversal time incurred during the methods of FIGS. 4 and 5 as described above. Thus, in the event that the previous step 510 causes an iterative flow length (which may be stored in the mapping correspondences as described above) to exceed a particular threshold (which may be a threshold experimentally deemed to cause traversal time to slow down computations to undesired lengths), a split operation may be performed according to the following steps:

The database may copy each key-value pair recorded in the delta encodings of the iterative flow into RAM, such as DRAM. The database may then sort the key-value pairs by key, according to any suitable sorting method as known to persons skilled in the art.

The database may divide the sorted keys at a midpoint or near a midpoint through the sorted order, compacting each delta encoding indexed lower than the midpoint into a first compacted delta encoding, and compacting each delta encoding indexed higher than the midpoint into a second compacted delta encoding.

The database may establish two new mappings in the mapping correspondences to the first compacted delta encoding and the second compacted delta encoding, respectively. In particular, the new mappings may both be to memory addresses different from the memory address of the head of the original iterative flow, since both compacted delta encodings may be written to respectively arbitrary memory addresses. Consequently, the child leaf node where the lookup key is indexed may be split into two child leaf nodes.

The database may then traverse upward to the parent of the child leaf node where the lookup key was indexed and determine, in accordance with insertion methods such as a B+ tree insertion method as known to persons skilled in the art, whether parent internal nodes should be split into parent and child nodes based on keys thereof, as a consequence of the split operation.

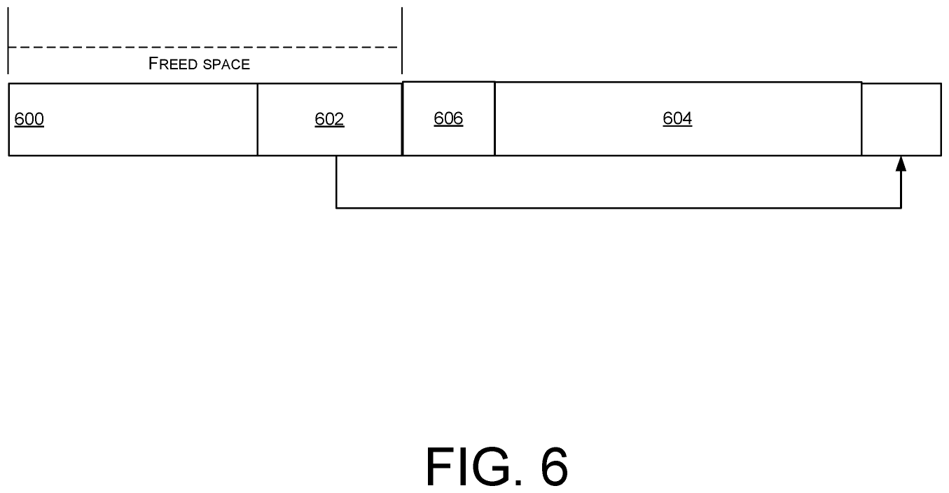

FIG. 6 illustrates defragmentation in a sequential data structure according to example embodiments of the present disclosure.

Since it is desirable, according to example embodiments of the present disclosure, to utilize sequential writes in persistent memory as described above in order to minimize write amplification and utilize write bandwidth of persistent memory, the sequential data structure as described herein should be defragmented upon detection of excessive fragments caused by portions of the sequential data structure becoming non-continuous.

As FIG. 6 illustrates, within a continuous address space range 600 in persistent memory, a sequential data structure according to example embodiments of the present disclosure has been written to a first range of addresses 602 and a second range of addresses 604, leaving free space 606 therebetween.

Thus, a database according to example embodiment of the present disclosure may be configured to detect a particular threshold of fragmentation among ranges of memory addresses occupied by the sequential data structure. A threshold may be defined by any factor pertaining to file fragmentation as known to persons skilled in the art, including number of fragments, number of gaps, sizes of fragments, sizes of gaps, and any combination of such factors.

The database may initialize a defragmentation thread, which may perform a defragmentation operation. The defragmentation operation may proceed by identifying a head range of addresses starting with sequential element which is at a head of an iterative flow. Each other range of addresses which does not start with a head of an iterative flow may be copied to a range of address following the head range. Then, delta encodings of the iterative flow may be compacted to prevent iterative flow length becoming overly long.

As illustrated, for example, the second range of addresses 604 may start with a head of an iterative flow, and the first range of addresses 602 may not. Thus, data in the first range of addresses 602 may be appended to the tail of the iterative flow at the second range of addresses 604, so that the free space 606 is no longer a gap between fragments.

Thus, the sequential data structure which encompasses one or more iterative flows may be maintained as a sequence of continuous memory addresses, facilitating sequential read and write. Since defragmentation operations append data to the end of occupied memory address ranges, free space for the write operations is assured and write amplification may be avoided.

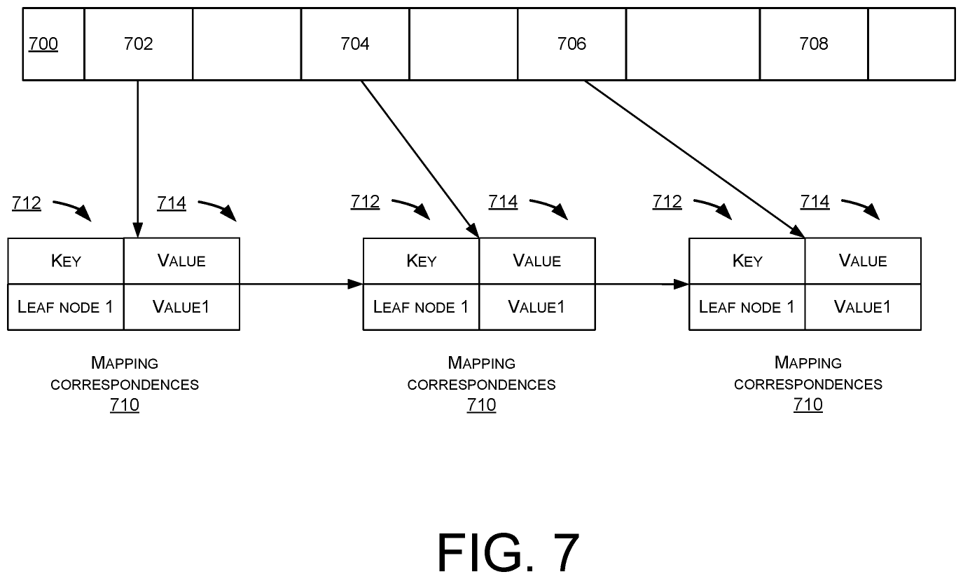

FIG. 7 illustrates recovery of mapping correspondences according to example embodiments of the present disclosure.

In the event of a system failure, such as power cycling, while those elements of the overall data structure stored on persistent memory will persist, those elements which are stored on RAM, such as the mapping correspondences, may be lost and require recovery. The database, accordingly, may initialize multiple recovery threads. Each recovery thread may be assigned to recovering contents of one or more mapping correspondences, each by traversing an entire iterative flow 700 from head to tail.

Since delta encodings 702, 704, 706, 708, . . . of each iterative flow are recorded from head to tail in chronological order, a respective recovery thread may reconstruct a corresponding mapping correspondence by identifying a key to which the iterative flow is indexed (i.e., a child leaf node key which is recorded in a log stream to which the child leaf node was mapped in the lost mapping correspondences). A new set of mapping correspondences 710 may be written to RAM with the key as a first element 712; the second element 714 may be rewritten dynamically as the recovery thread traverses the iterative flow, the second element being replaced with each sequential element traversed in the iterative flow until the head of the iterative flow is found, whereupon a pointer to the last sequential element may be left mapped to the key, re-establishing the mapping between the key and the head of the iterative flow.

Thus, example embodiments of the present disclosure overcome the non-persistence of part of the data structures underlying a database being stored on RAM in this manner. Since it is desirable to randomly access the mapping correspondences instead of the data stored on persistent memory, avoiding read and write amplification, implementation of recovery compensates for the downsides of this data being susceptible to system failures such as power cycling.

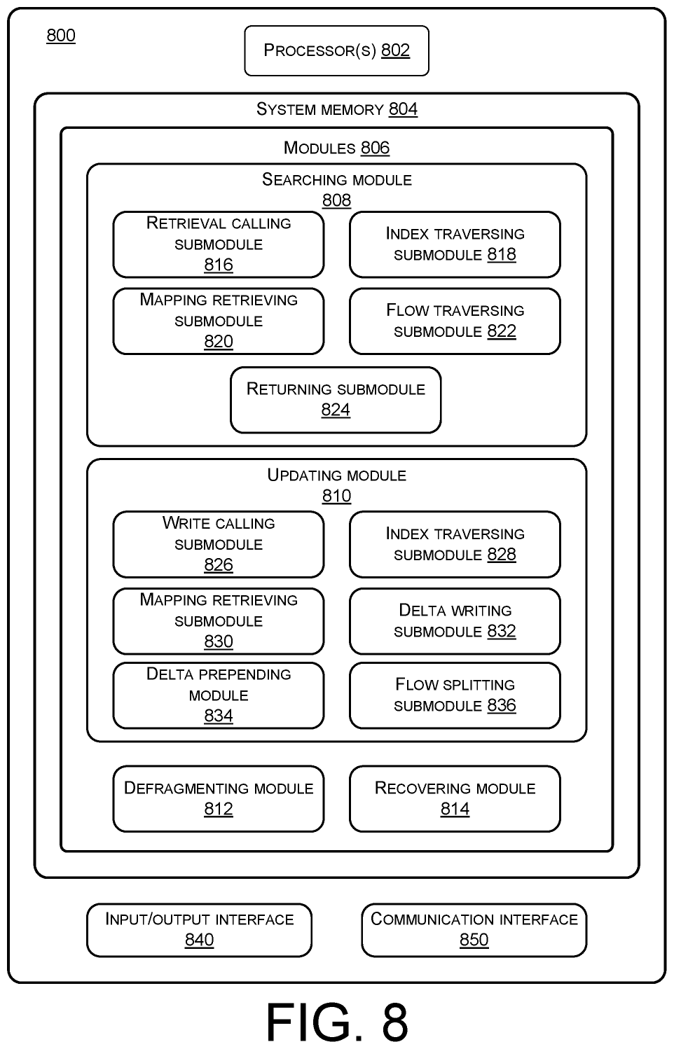

FIG. 8 illustrates an example computing system 800 for implementing the data structures described above optimized for read and write performance in persistent memory of computing systems.

The techniques and mechanisms described herein may be implemented by multiple instances of the computing system 800, as well as by any other computing device, system, and/or environment. The computing system 800 may be any varieties of computing devices, such as personal computers, personal tablets, mobile devices, other such computing devices operative to perform matrix arithmetic computations. The computing system 800 shown in FIG. 8 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 800 may include one or more processors 802 and system memory 804 communicatively coupled to the processor(s) 802. The processor(s) 802 and system memory 804 may be physical or may be virtualized and/or distributed. The processor(s) 802 may execute one or more modules and/or processes to cause the processor(s) 802 to perform a variety of functions. In embodiments, the processor(s) 802 may include a central processing unit (“CPU”), a GPU, an NPU, a TPU, any combinations thereof, or other processing units or components known in the art. Additionally, each of the processor(s) 802 may possess its own local memory, which also may store program modules, program data, and/or one or more operating systems.

Depending on the exact configuration and type of the computing system 800, the system memory 804 may be volatile, such as RAM, non-volatile, such as ROM, flash memory, miniature hard drive, memory card, and the like, or some combination thereof, but further includes persistent memory as described above. The system memory 804 may include one or more computer-executable modules 806 that are executable by the processor(s) 802. The modules 806 may be hosted on a network as services for a data processing platform, which may be implemented on a separate system from the computing system 800.

The modules 806 may include, but are not limited to, a searching module 808, an updating module 810, a defragmenting module 812, and a recovering module 814. The searching module 808 may further include a retrieval calling submodule 816, an index traversing submodule 818, a mapping retrieving submodule 820, a flow traversing submodule 822, and a returning submodule 824. The updating module 810 may further include a write calling submodule 826, an index traversing submodule 828, a mapping retrieving submodule 830, a delta writing submodule 832, a delta prepending submodule 834, and a flow splitting submodule 836.

The defragmenting module 812 may be configured to initialize a defragmenting thread as described above with reference to FIG. 5.

The recovering module 814 may be configured to initialize recovery threads as described above with reference to FIG. 6.

The retrieval calling submodule 816 may be configured to respond to a retrieval call having a key parameter made to a database as described above with reference to step 402.

The index traversing submodule 818 may be configured to look up a first element corresponding to the key by traversing an indexed data structure as described above with reference to step 404.

The mapping retrieving submodule 820 may be configured to retrieve a second element mapped to the first element by a mapping correspondence as described above with reference to step 406.

The flow traversing submodule 822 may be configured to traverse an iterative flow implemented on a sequential database structure starting from the second element as described above with reference to step 408.

The returning submodule 824 may be configured to return a result of the retrieval call as described above with reference to step 410.

The write calling submodule 826 may be configured to respond to a write call having a key parameter and a value parameter made to a database as described above with reference to step 502.

The index traversing submodule 828 may be configured to look up a first element corresponding to the key by traversing an indexed data structure as described above with reference to step 504.

The mapping retrieving submodule 830 may be configured to retrieve a second element mapped to the first element by a mapping correspondence as described above with reference to step 506.

The delta writing submodule 832 may be configured to write a delta encoding from the key and the value in persistent memory as described above with reference to step 508.

The delta prepending submodule 834 may be configured to prepend the delta encoding to the second element as described above with reference to step 510.

The flow splitting submodule 836 may be configured to split the iterative flow into two iterative flows as described above with reference to step 512.

The system 800 may additionally include an input/output (“I/O”) interface 840 and a communication module 850 allowing the system 800 to communicate with other systems and devices over a network, such as server host(s) as described above. The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.) and/or persistent memory as described above. The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), non-volatile memory (“NVM”), non-volatile random-access memory (“NVRAM”), phase-change memory (“PCM”), resistive random-access memory (“ReRAM”), magnetoresistive random-access memory (“MRAM”), non-volatile dual in-line memory modules (“NVDIMM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-7. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

By the abovementioned technical solutions, the present disclosure provides indexed data structures optimized for read and write performance in persistent memory of computing systems. The data structure provides for storing data which may be searched by traversing an indexed data structure while still being sequentially written to persistent memory, so that the stored data may be accessed more efficiently than on non-volatile storage, while maintaining persistence against system failures such as power cycling. Mapping correspondences between leaf nodes of an indexed data structure and sequential elements of a sequential data structure may be stored on RAM, facilitating fast random access. Data writes are recorded in the form of appended delta encodings which may be periodically compacted, avoiding write amplification inherent in persistent memory. Delta encodings are stored in iterative flows, such as log streams, enabling access to multiple streams of data in parallel, while also providing a chronological record to enable recovery of mapping correspondences in RAM, guarding non-persistent data against system failures.

### Example Clauses

A. A method comprising: receiving, by a database, a call having a key parameter, the database comprising a data structure stored at least in part on random-access memory and at least in part on persistent memory; looking up a first element corresponding to the key by traversing an indexed data structure stored on persistent memory; and retrieving a second element mapped to the first element by a mapping correspondence stored on random-access memory.

B. The method as paragraph A recites, further comprising traversing an iterative flow implemented on a sequential database structure starting from the second element.

C. The method as paragraph B recites, wherein multiple iterative flows are traversed in parallel by multiple threads of the database.

D. The method as paragraph A recites, wherein the call further has a value parameter, and further comprising writing a delta encoding from the key and the value in persistent memory.

E. The method as paragraph D recites, further comprising prepending the delta encoding to the second element.

F. The method as paragraph E recites, further comprising compacting the delta encoding with a plurality of delta encodings of an iterative flow implemented on a sequential database structure starting from the second element.

G. The method as paragraph F recites, further comprising splitting the iterative flow into two iterative flows.

H. A system comprising: one or more processors; and memory communicatively coupled to the one or more processors, the memory storing computer-executable modules executable by the one or more processors that, when executed by the one or more processors, perform associated operations, the computer-executable modules comprising: a searching module, the searching module further comprising: a retrieval calling submodule configured to respond to a retrieval call having a key parameter made to a database; an index traversing submodule configured to look up a first element corresponding to the key by traversing an indexed data structure stored on persistent memory; and a mapping retrieving submodule configured to retrieve a second element mapped to the first element by a mapping correspondence stored on random-access memory.

I. The system as paragraph H recites, wherein the searching module further comprises a flow traversing submodule configured to traverse an iterative flow implemented on a sequential database structure starting from the second element.

J. The system as paragraph I recites, wherein multiple iterative flows are traversed in parallel by multiple threads of the database.

K. The system as paragraph H recites, further comprising an updating module, the updating module further comprising: a write calling submodule configured to respond to a write call having a key parameter and a value parameter made to a database; an index traversing submodule configured to look up a first element corresponding to the key by traversing an indexed data structure stored on persistent memory; and a mapping retrieving submodule configured to retrieve a second element mapped to the first element by a mapping correspondence stored in random-access memory; and a delta writing submodule configured to write a delta encoding from the key and the value in persistent memory.

L. The system as paragraph K recites, wherein the updating module further comprises a delta prepending submodule configured to prepend the delta encoding to the second element.

M. The system as paragraph L recites, wherein the delta writing submodule is further configured to compact the delta encoding with a plurality of delta encodings of an iterative flow implemented on a sequential database structure starting from the second element.

N. The method as paragraph M recites, further comprising a flow splitting submodule configured to split the iterative flow into two iterative flows.

O. A computer-readable storage medium storing computer-readable instructions executable by one or more processors, that when executed by the one or more processors, cause the one or more processors to perform operations comprising: receiving, by a database, a call having a key parameter, the database comprising a data structure stored at least in part on random-access memory and at least in part on persistent memory; looking up a first element corresponding to the key by traversing an indexed data structure stored on persistent memory; and retrieving a second element mapped to the first element by a mapping correspondence stored on random-access memory.

P. The computer-readable storage medium as paragraph O recites, wherein the operations further comprise traversing an iterative flow implemented on a sequential database structure starting from the second element.

Q. The computer-readable storage medium as paragraph P recites, wherein multiple iterative flows are traversed in parallel by multiple threads of the database.

R. The computer-readable storage medium as paragraph O recites, wherein the call further has a value parameter, and the operations further comprise writing a delta encoding from the key and the value in persistent memory.

S. The computer-readable storage medium as paragraph R recites, wherein the operations further comprise prepending the delta encoding to the second element.

T. The computer-readable storage medium as paragraph S recites, wherein the operations further comprise compacting the delta encoding with a plurality of delta encodings of an iterative flow implemented on a sequential database structure starting from the second element.

U. The computer-readable storage medium as paragraph T recites, wherein the operations further comprise splitting the iterative flow into two iterative flows.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, by a database, a call having a key parameter, the database comprising a data structure stored at least in part on random-access memory and at least in part on persistent memory;
looking up a first element corresponding to the key by traversing an indexed data structure stored on persistent memory; and
retrieving a second element mapped to the first element by a mapping correspondence stored on random-access memory.

2. The method of claim 1, further comprising traversing an iterative flow implemented on a sequential database structure starting from the second element.

3. The method of claim 2, wherein multiple iterative flows are traversed in parallel by multiple threads of the database.

4. The method of claim 1, wherein the call further has a value parameter, and further comprising writing a delta encoding from the key and the value in persistent memory.

5. The method of claim 4, further comprising prepending the delta encoding to the second element.

6. The method of claim 5, further comprising compacting the delta encoding with a plurality of delta encodings of an iterative flow implemented on a sequential database structure starting from the second element.

7. The method of claim 6, further comprising splitting the iterative flow into two iterative flows.

8. A system comprising:
one or more processors; and
memory communicatively coupled to the one or more processors, the memory storing computer-executable modules executable by the one or more processors that, when executed by the one or more processors, perform associated operations, the computer-executable modules comprising:
a searching module, the searching module further comprising:
a retrieval calling submodule configured to respond to a retrieval call having a key parameter made to a database;
an index traversing submodule configured to look up a first element corresponding to the key by traversing an indexed data structure stored on persistent memory; and
a mapping retrieving submodule configured to retrieve a second element mapped to the first element by a mapping correspondence stored on random-access memory.

9. The system of claim 8, wherein the searching module further comprises a flow traversing submodule configured to traverse an iterative flow implemented on a sequential database structure starting from the second element.

10. The system of claim 9, wherein multiple iterative flows are traversed in parallel by multiple threads of the database.

11. The system of claim 8, further comprising an updating module, the updating module further comprising:
a write calling submodule configured to respond to a write call having a key parameter and a value parameter made to a database;
an index traversing submodule configured to look up a first element corresponding to the key by traversing an indexed data structure stored on persistent memory; and a mapping retrieving submodule configured to retrieve a second element mapped to the first element by a mapping correspondence stored in random-access memory; and
a delta writing submodule configured to write a delta encoding from the key and the value in persistent memory.

12. The system of claim 11, wherein the updating module further comprises a delta prepending submodule configured to prepend the delta encoding to the second element.

13. The system of claim 12, wherein the delta writing submodule is further configured to compact the delta encoding with a plurality of delta encodings of an iterative flow implemented on a sequential database structure starting from the second element.

14. The system of claim 13, further comprising a flow splitting submodule configured to split the iterative flow into two iterative flows.

15. A computer-readable storage medium storing computer-readable instructions executable by one or more processors, that when executed by the one or more processors, cause the one or more processors to perform operations comprising:
receiving, by a database, a call having a key parameter, the database comprising a data structure stored at least in part on random-access memory and at least in part on persistent memory;
looking up a first element corresponding to the key by traversing an indexed data structure stored on persistent memory;
and retrieving a second element mapped to the first element by a mapping correspondence stored on random-access memory.

16. The computer-readable storage medium of claim 15, wherein the operations further comprise traversing an iterative flow implemented on a sequential database structure starting from the second element.

17. The computer-readable storage medium of claim 16, wherein multiple iterative flows are traversed in parallel by multiple threads of the database.

18. The computer-readable storage medium of claim 15, wherein the call further has a value parameter, and the operations further comprise writing a delta encoding from the key and the value in persistent memory.

19. The computer-readable storage medium of claim 18, wherein the operations further comprise prepending the delta encoding to the second element.

20. The computer-readable storage medium of claim 19, wherein the operations further comprise compacting the delta encoding with a plurality of delta encodings of an iterative flow implemented on a sequential database structure starting from the second element.
